(19) United States
(12) Patent Application Publication
(10) Pub. No.: US 2017/0111427 A1
(43) Pub. Date: Apr. 20, 2017

(54) INTERNET INFORMATION RETRIEVAL SYSTEM AND METHOD

(71) Applicant: MICHAEL GLOBINSKY, RAANANA (IL)

(72) Inventor: MICHAEL GLOBINSKY, RAANANA (IL)

(21) Appl. No.: 15/292,148

(22) Filed: Oct. 13, 2016

Related U.S. Application Data
(60) Provisional application No. 62/243,071, filed on Oct. 18, 2015.

(51) Int. Cl. H04L 29/08; H04W 4/14

(52) U.S. Cl. CPC H04L 67/02; H04W 4/14; H04L 67/10

(57) ABSTRACT

An Internet information retrieval system, including a user interface, for defining specific information of interest, being information which is more specific than keywords and keywords with relations between them, a schedule for carrying out an Internet information retrieval, and alerting destination, a facility for retrieving Web content that might include the specific information of interest, wherein the presence of the specific information of interest, for being retrieved by the facility includes: presence of at least two different events, each retrieved from a different source of information, and at least one logic relation between the at least two retrieved different events, thereby the alert executed upon the presence of the specific information allows looking forward to a new event, estimated, by other than the Internet information retrieval system, to be consequent to the at least two different events.

### CROSS-REFERENCE TO RELATED APPLICATIONS

This application claims the benefit of priority from U.S. Provisional Application No. US 62/243,071, filed Oct. 18, 2015, the disclosure of which is incorporated herein by reference.

### FIELD

The invention relates to the field of Web information retrieval. More particularly, the invention relates to a system and method for carrying out Internet information retrieval.

### BACKGROUND

RSS (Really Simple Syndication) is a programming facility that allows a server, such as an Internet server, to send to client programs parts of a document, such as a Web page, that has recently been updated, while they are separated from the permanent content of the document. Client software for this purpose may be dedicated programs, or other Web sites tailored to this purpose.

The major use of RSS is concise and summarized presentation of the material that has been updated in a URL (Uniform Resource Locator), without browsing the entire content presented therein. The conciseness allows a user to follow changes in his favorite Web sites with regard to specific information of interest, in a substantially short time.

However, this technology does not give a solution for searching certain information in a Web page, such as an alert when the price of a certain stock share goes under a predetermined threshold, a new bid on a certain product, whenever the price of an item offered for sale in a bid falls under a certain level, and so on.

### SUMMARY OF THE INVENTION

It is an object of the invention to provide a solution to the above-mentioned and other problems of the prior art.

Other objects of the invention will become apparent as the description proceeds.

In order to facilitate the reading to follow, the following terms and acronyms are defined:

URL, the acronym of Uniform Resource Location, refers herein to a string of characters which defines the location of a file or program on the Internet. A Web page, a Web site, a folder of a server accessible via the Internet, and so on, are examples of URLs.

The term Web terminal refers herein to any facility that can access a URL via the Internet. A personal computer coupled with a Web browser, a cellular telephone that has Internet access, and so on, are examples of Web terminals.

The term User interface means the space where interaction between humans and machines occurs. The goal of interaction between a human and a machine at the user interface is effective operation and control of the machine, and feedback from the machine which aids the operator in making operational decisions. Examples of this broad concept of user interfaces include the interactive aspects of computer operating systems, hand tools, heavy machinery operator controls, and process controls.

The term Web content refers herein to memory means for storing information retrieved through the Internet, such as a Web page, a record of a database accessible via the Internet, and actually, any URL.

The term Internet Information Retrieval refers herein to any form of Web content retrieval. This may include carrying out a search via an Internet search engine (e.g., Google, Yahoo, etc.) and retrieving the resulting Web pages, accessing a database available through the Internet and retrieving a record therefrom, retrieving a specified Web page, and so on. In other words, the term refers to a session of retrieving information from the Internet.

The term Specific information of interest refers herein to information which is more specific than keywords and keywords with relations between them, which are the meaning for defining a search with a search engine.

In one aspect, the invention is directed to an Internet information retrieval system, comprising:
a user interface, for defining:
   (a) specific information of interest to be retrieved in an Internet information retrieval session;
   (b) a schedule for carrying out the Internet information retrieval session; and
   (c) alerting destination (such as telephone numbers) to which an alert is to be sent upon detection specific information of interest in the Internet information retrieval session;
a facility for retrieving Web content that might comprise the specific information of interest;
a Web content analyzer, for analyzing whether retrieved Web content comprises the specific information of interest; and
an alerting facility, for posting an alert to the alerting destination upon detecting presence of the specific information of interest in the retrieved Web pages.

There is a major difference between conducting a search with search engines such as Google and Yahoo and the invention: While a search engine scans Web sites and relates them to keywords found therein, according to the invention, after Web pages that may comprise the specific information of interest have been retrieved, a more specific analysis is carried out in order to detect whether a retrieved Web page comprises the specific information of interest.

As such, while a search engine uses merely a list of keywords, sometimes with logical relations between them, such as AND, OR, the invention uses a more specified user interface in order to define more specific information. Thus, defining the Web pages to retrieve (as in search engines such as Google and Yahoo) is only the first step in the invention. The next step is detecting whether the retrieved Web pages comprise the specific information of interest.

The invention uses two facilities for retrieving Web content in an Internet information retrieval session:
A facility for retrieving Web content, which may be a program that activates a Web search such as of Google and Yahoo, and retrieves the Web pages pointed out by the search. Additionally, the facility may retrieve specified Web pages, if it is possible that they comprise the specific information of interest; and
A Web content analyzer, for analyzing whether the retrieved Web content comprises the specific information of interest.

In other words, according to embodiments of the invention, an Internet information retrieval comprises two stages: in the first stage, Web content that might comprise the specific information of interest is retrieved from the internet, and in the next stage, the retrieved Web content is analyzed for detecting presence of the specific information of interest.

In order to allow a user to define the specific information of interest, the system might use a user interface oriented for each type of specific information of interest.

According to one embodiment of the invention, the user interface is oriented for defining a stock, the price of which is to be retrieved.

According to another embodiment of the invention, the user interface is oriented for defining a price of an item in an auction.

According to yet another embodiment of the invention, the user interface is oriented for defining specific information of interest present in a URL.

According to yet another embodiment of the invention, the user interface is oriented for defining new items of specific information of interest in a URL.

Preferably, the alert is carried out via an SMS message.

The system may further comprise memory means, for storing the definitions, for further enhancement.

In another aspect, the invention is directed to an Internet information retrieval method, comprising the steps of:
defining:
   (a) specific information of interest to be retrieved in an Internet information retrieval session;
   (b) a schedule for carrying out the Internet information retrieval session; and
   (c) alerting destination (such as telephone numbers) to which an alert is to be sent upon detecting the specific information of interest in the Internet information retrieval session;
carrying out an Internet information retrieval according to the schedule, for retrieving Web pages that might comprise the specific information of interest;
analyzing whether Web content retrieved in the Internet information retrieval comprises the specific information of interest; and
upon detecting the specific information of interest in the retrieved content, alerting a user via the alerting destination.

For example, a user defines with the user interface on his Web terminal (e.g., personal computer) specific information of interest, such as if the price of a stock goes beyond a certain value, a new bid on a certain item, new articles from a certain reporter, an updated news item of a certain issue, and so on.

Additionally, the user defines one or more cellular telephone(s) to where an alert is to be sent upon detecting the specific information of interest in retrieved Web content.

Additionally, the user defines the schedule for carrying out the Internet information retrieval, e.g., once per hour, once per day, on 18:00 PM each Sunday, and so on.

When an Internet information retrieval is carried out according to the defined schedule, and specific information of interest is found, the user is alerted about it via the defined cellular telephone(s).

This approach provides several advantages over a traditional Web search. For example, this approach allows a user to obtain focused specific information of interest, while traditional Web searches provide less focused results. Thus, although he must spend more time in defining a query which provides the best results, after the query has been defined, the information retrieval is carried out periodically, allowing the user to be informed at his desired frequency about new/updated information items of interest.

Another advantage is the combination of a focused Web search with the benefits of an RSS

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments and features of the invention are described herein in conjunction with the following drawings:

Each of FIGS. 1 to 3 schematically illustrates a user interface for defining parameters of an Internet information retrieval, according to one embodiment of the invention.

FIG. 4 schematically illustrates the major modules of a system for Internet information retrieval, according to one embodiment of the invention.

FIG. 5 is a flowchart that schematically illustrates an Internet information retrieval method, according to one embodiment of the invention.

It should be understood that the drawings are not necessarily drawn to scale.

### DETAILED DESCRIPTION

The invention will be understood from the following detailed description of embodiments thereof, which are meant to be descriptive and not limiting. For the sake of brevity, some well-known features, methods, systems, procedures, components, circuits, and so on, are not described in detail.

FIG. 1 schematically illustrates a user interface for defining parameters of an Internet information retrieval, according to one embodiment of the invention.

In this example of the embodiment, the user defines the search engines of interest, such as Google and Yahoo.

In addition, the user defines keywords for conducting the search.

In addition, the user defines the search frequency, such as once per hour, once per day, every three hours, and so on.

The user also defines whether to send an alert about detected retrieved information to predetermined cellular telephone(s). The alert may be carried out by an SMS message, a voice message, and so on. The telephone number(s) to where an alert is to be sent is defined separately.

FIG. 2 schematically illustrates a user interface for defining parameters of an Internet information retrieval, according to one embodiment of the invention.

According to this embodiment of the invention, the user interface allows defining a Web site in which information is to be retrieved, the type of information (e.g., reporter, subject), text to be searched, and so on.

In this way, a user can be alerted when a new article of a certain author is published on a certain Web site, as depicted in the first line of the table of FIG. 2; when updated news of a another subject turn to a certain state, as depicted in the second line of the table of FIG. 2; and so on.

According to one embodiment, the user may be alerted when the new article of the certain author is published on the certain Web site, as depicted in the first line of the table of FIG. 2 only if also the updated news of the other subject turn to the certain state, as depicted in the second line of the table of FIG. 2.

In general, the alert is once two of more different events, each retrieved from a different source of information, occur; and one or more logic relations are valid between the different events.

The alert looks forward to a new event, estimated, by other than the Internet information retrieval system, to be consequent to the at least two different events.

For example, the first event may be a bomb in a first country; the second event may be a appreciation of currency of a second country; the logic relation is that the second event occurs 3 to 5 days after the first event. This may look forward to a new event, being a steady appreciation of the currency of the second country.

FIG. 3 schematically illustrates a user interface for defining parameters of an Internet information retrieval, according to one embodiment of the invention.

According to this embodiment of the invention, the user defines one or more URLs, such as Web pages. For each Web page, the user defines a condition, such as Greater than, Lesser than, Equal to, and so on.

The user also defines a value to be compared to, such as last bid, a share price, and so on.

Of course, these are simplified examples of user interfaces for defining retrieved information, for the purpose of demonstration, and in practice, a more sophisticated user interface can be designed.

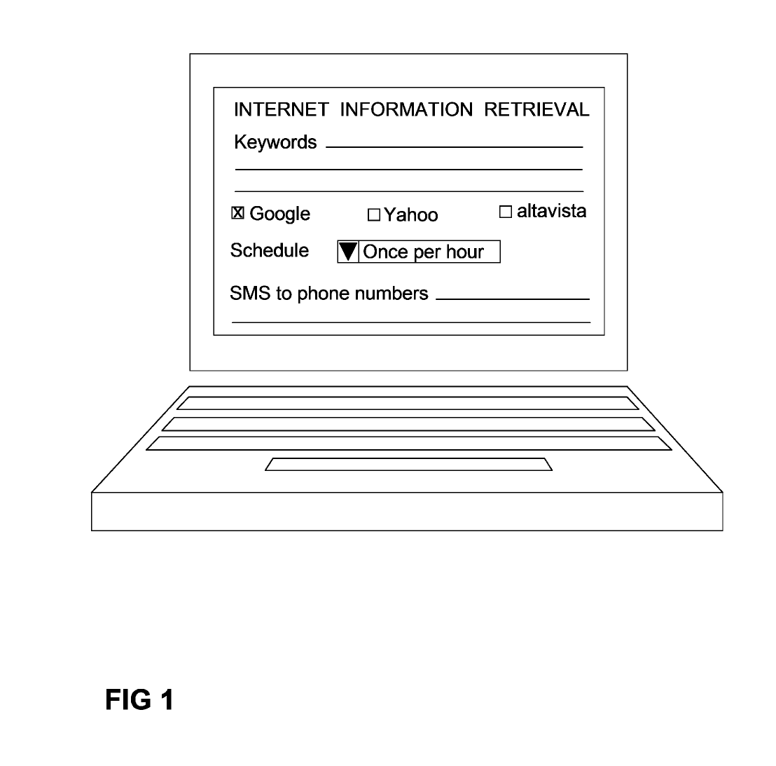

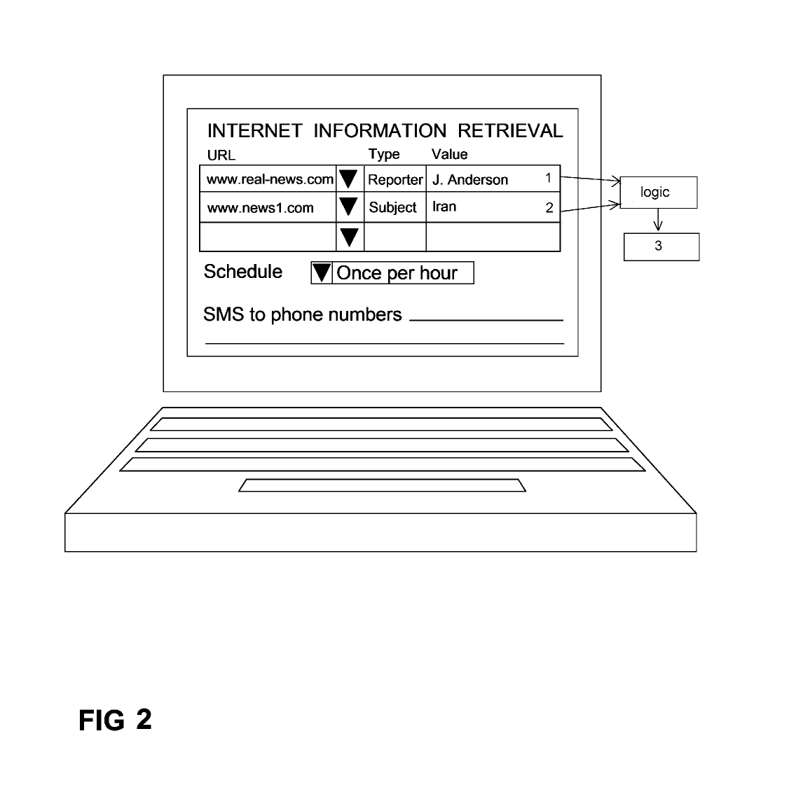

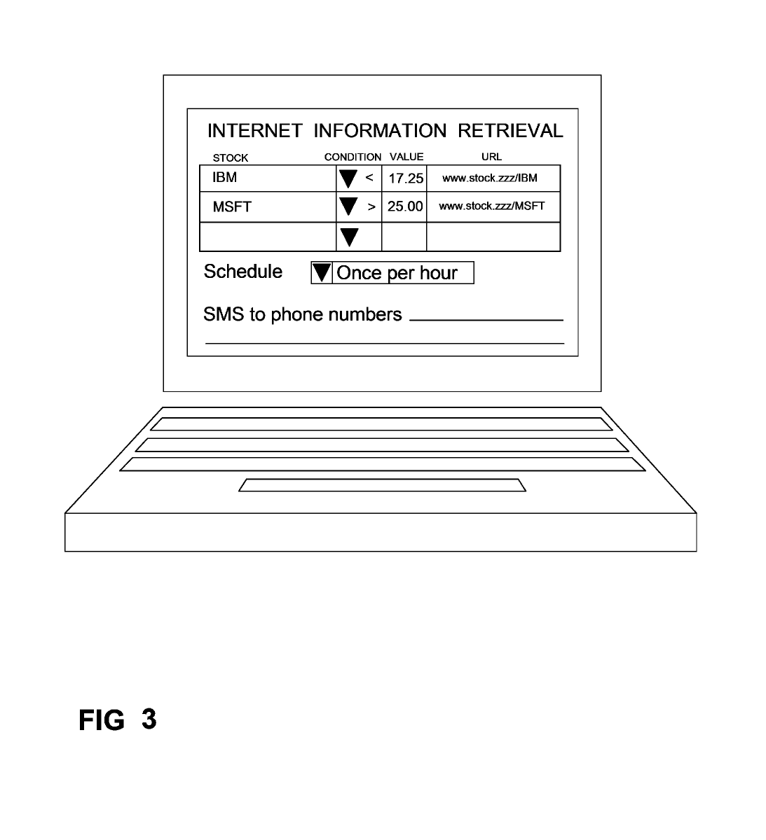

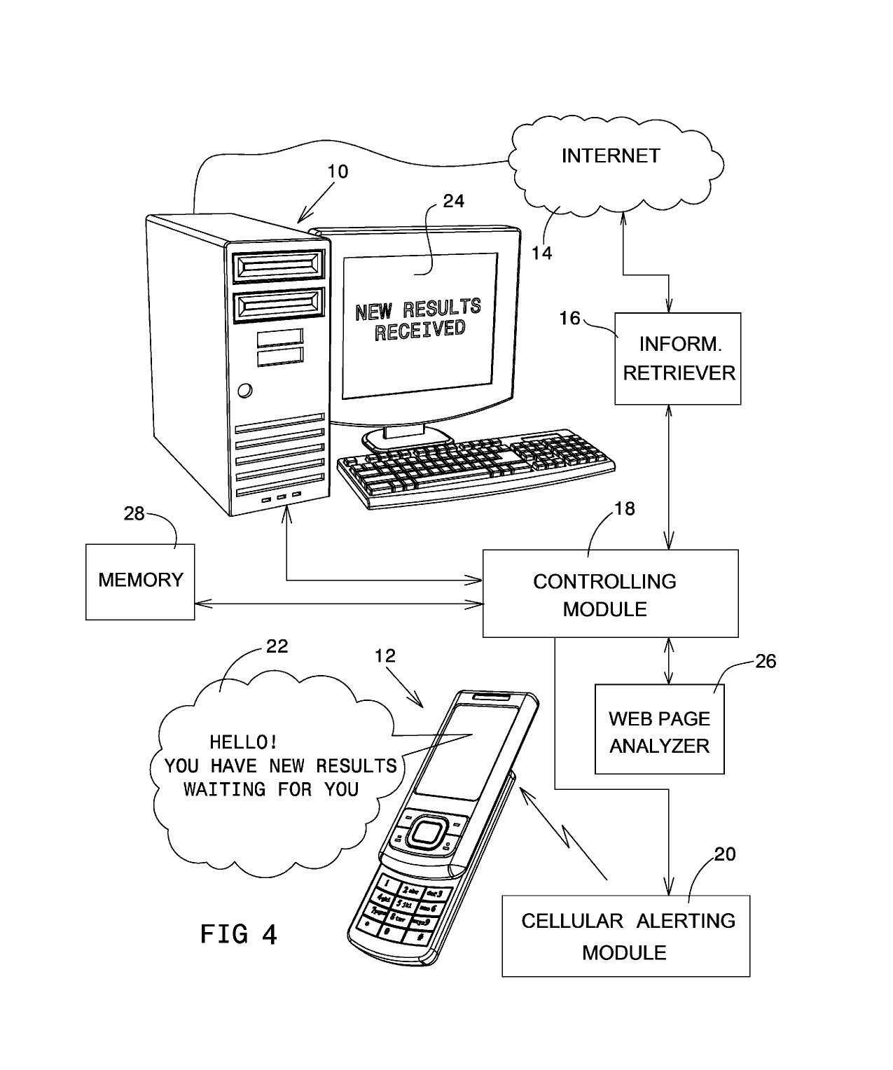

FIG. 4 schematically illustrates the major modules of a system for Internet information retrieval, according to one embodiment of the invention.

The parameters specified by a user using a user interface such as those illustrated in FIGS. 1 to 3 are stored in memory 28 of a user's computer 10. Memory 28 is of a type that does not lose its content when the computer's power is turned off, such as Flash memory, disc storage, and so on.

At computer 10, a controlling module 18, such as a software application, is being executed. The controlling module is in charge of activating an information retriever module 16 according to the defined schedule thereof, as stored in memory 28.

The retrieved Web pages are analyzed by a Web page analyzer 26, in order to detect whether the Web page contains the new information the user is looking for. When positive results are reported by the Web page analyzer, the controlling module activates a cellular alerting module 20 to inform the user thereof that the information he is looking for has been found.

The cellular alerting module may send an alert by an SMS (Short Messaging System) message 12 comprising text 22. The alert may be in other forms, such as a voice message. When the alert comprises textual information, it can specify the subject of the found result, and so on.

Alternatively or additionally, the controlling module may present an alert on display 24 of computer 10, especially when a user is logged onto the computer, which indicates that the user is exposed to alerts presented on the computer's output devices (display, speakers, and so on).

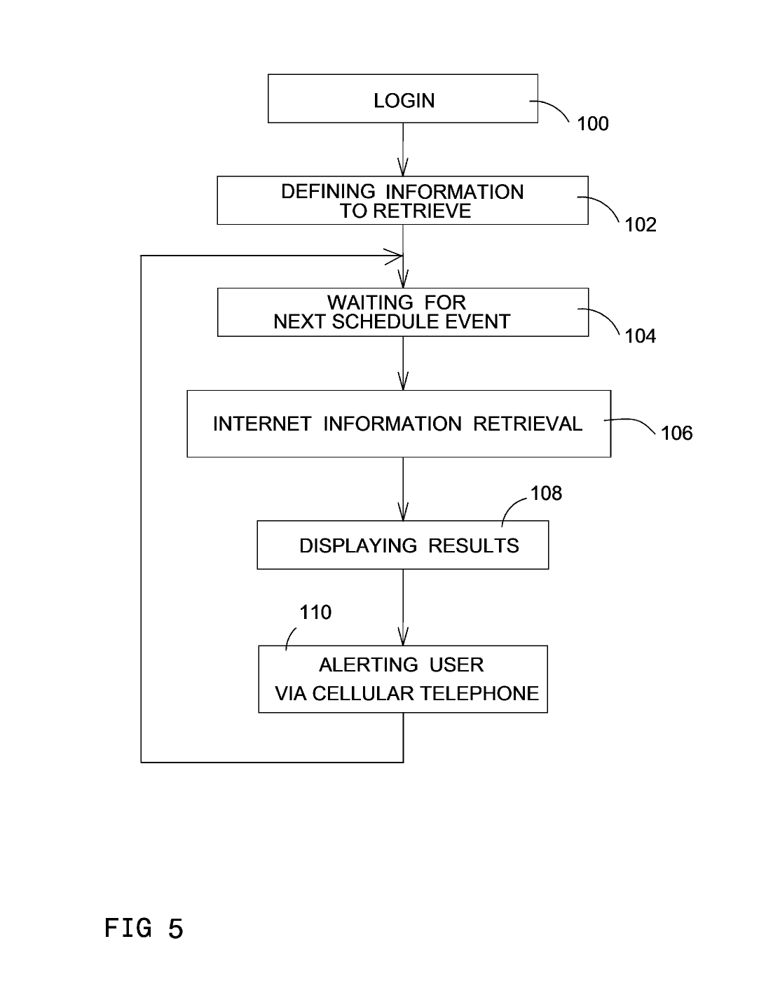

FIG. 5 is a flowchart that schematically illustrates information flow in an Internet information retrieval method, according to one embodiment of the invention.

At step 100, a user activates the system, and logs in.

At step 102, the user defines the information to be retrieved. The information to be retrieved may be, for example, new articles of an author, whether the price of a stock has passed beyond a certain value, the lowest price of an item in all the Web auctions carried out, new apartments for sale in a certain area, and so on.

Some information to be retrieved may suit for a Web search, and therefore can be carried out by Internet search engines, such as Yahoo and Google. The search may be carried out in several Internet search engines simultaneously. However, such a search cannot provide an answer to queries such as “inform me when the price of IBM stock goes under a certain value”. For such a query, a different approach should be taken, such as opening a certain Web page (e.g., the page that presents the IBM stock), and looking for a predefined place in the page, where the current information is expected to be. In addition, for defining such a query, the user interface may be dedicated therefor.

At step 104, the system waits for the next scheduled event. For example, if the Internet information retrieval is carried out once per hour, the system waits one hour from the previous information retrieval session (step 106).

At step 106, an Internet information retrieval is carried out. As explained above, the retrieval may be carried out via a search by one or more search engines, retrieving a predefined Web page and examining its content, and so on.

At step 108, if positive results have been found, at step 108 the results may be displayed on a display of the user's computer.

At step 110, the user is alerted about positive results. The alert may be carried out by a cellular telephone, by a pop-up window on the user's display, and so on.

In the figures and/or description herein, the following reference numerals have been mentioned:

numeral 10 denotes a user computer;

numeral 12 denotes an SMS message;

numeral 14 denotes the Internet;

numeral 16 denotes an information retriever module;

numeral 18 denotes a controlling module (management software);

numeral 20 denotes a cellular alerting module;

numeral 22 denotes an SMS text;

numeral 24 denotes a computer display;

numeral 26 denotes a Web page analyzer;

numeral 28 denotes a computer memory; and

each of numerals 100 to 110 denotes a method step.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. An Internet information retrieval system, comprising:
a user interface, for defining:
(a) specific information of interest, being information which is more specific than keywords and keywords with relations between them;
(b) a schedule for carrying out an Internet information retrieval; and
(c) alerting destination;
a facility for retrieving Web content that might comprise the specific information of interest;
a Web content analyzer, for analyzing whether retrieved Web content comprises said specific information of interest; and
an alerting facility, for posting an alert to said alerting destination upon detecting presence of said specific information of interest in the retrieved Web pages,
wherein said presence of said specific information of interest, for being retrieved by said facility comprises:
presence of at least two different events, each retrieved from a different source of information; and
at least one logic relation between said at least two retrieved different events,
thereby said alert executed upon said presence of said specific information allows looking forward to a new event, estimated, by other than said Internet information retrieval system, to be consequent to said at least two different events.

2. A system according to claim 1, wherein the user interface is oriented for defining a stock the price of which is to be retrieved.

3. A system according to claim 1, wherein the user interface is oriented for defining a price of an item in an auction.

4. A system according to claim 1, wherein the user interface is oriented for defining specific information of interest present in a URL.

5. A system according to claim 1, wherein the user interface is oriented for defining new items of specific information of interest in a URL.

6. A system according to claim 1, wherein said alert is carried out via an SMS message.

7. A system according to claim 1, further comprising memory means, for storing said definitions, for further enhancement.

8. A system according to claim 1, wherein said user interface comprises means for defining a condition.

9. A system according to claim 1, wherein said alerting destination comprises one or more telephone numbers.

10. An Internet information retrieval method, comprising the steps of:
defining:
(a) specific information of interest, being information which is more specific than keywords and keywords with relations between them;
(b) a schedule for carrying out an Internet information retrieval session; and
(c) alerting destination to which an alert is to be sent upon detecting said specific information of interest in said Internet information retrieval session;
carrying out an Internet information retrieval according to a defined schedule, for retrieving Web pages that might comprise said specific information of interest;
analyzing whether Web content retrieved comprises the specific information of interest; and
upon detecting said specific information of interest in a retrieved content, alerting a user via said alerting destination.
wherein said step of detecting said specific information of interest in said retrieved content comprises:
detecting at least two different events, each retrieved from a different source of information; and
detecting presence of at least one logic relation between said at least two retrieved different events,
thereby said alert executed upon said presence of said specific information allows looking forward to a new event, estimated to be consequent to said at least two different events.

11. A method according to claim 10, wherein said user interface is oriented for defining a stock the price of which is to be retrieved.

12. A method according to claim 10, wherein said user interface is oriented for defining a price of an item in an auction.

13. A method according to claim 10, wherein said user interface is oriented for defining specific information of interest present in a URL.

14. A method according to claim 10, wherein said user interface is oriented for defining new items of specific information of interest in a URL.

15. A method according to claim 10, wherein said alert is carried out via an SMS message.

16. A method according to claim 10, further comprising the step of storing said definitions, for further enhancement.

17. A method according to claim 10, wherein said user interface comprises defining a condition.

18. A method according to claim 10, wherein said alerting destination comprises one or more telephone numbers.
